(19) United States
(12) Patent Application Publication
(10) Pub. No.: US 2004/0125990 A1
(43) Pub. Date: Jul. 1, 2004

(54) Method and apparatus for asperity detection

(75) Inventors: Cathryn Goodman, Glen Ellyn, IL (US); Behnam Bavarian, Newport Coast, CA (US); Mark Lill, Elgin, IL (US)

Correspondence Address: FITCH EVEN TABIN AND FLANNERY, 120 SOUTH LA SALLE STREET, SUITE 1600, CHICAGO, IL, 60603-3406, US

(73) Assignee: Motorola, Inc.

(21) Appl. No.: 10/329,935

(22) Filed: Dec. 26, 2002

(51) Int. Cl. G06K 9/00

(52) U.S. Cl. 382/115

(57) ABSTRACT

An asperity detection apparatus and method wherein asperities are detected over a period of time. The resultant information can be used to characterize the asperities as three dimensional structures and/or with respect to their elastic and/or resilient behaviors or properties over time.

### TECHNICAL FIELD

This invention relates generally to asperity detection.

### BACKGROUND

Asperities (that is, small projections from a surface) of various kinds are often unique to a given individual, with fingerprints and palm prints being amongst the best known and most frequently utilized. Various devices have been proposed to actively capture such characterizing asperities to facilitate recognition and/or authorization methodologies. Various enabling technologies, including thermal-based, capacitance-based, ultrasonic-based, pressure-based, and optical-based systems have all been proposed to facilitate the realization of such devices. To one extent or another, such devices all tend to capture features of the asperities. Fingerprint features, also called minutia, typically include locations where the friction ridges begin, end, or bifurcate.

It is known to base automated asperity analysis processes upon such minutia. For example, so-called automated fingerprint identification systems make automatic comparisons between the detected minutia of a given fingerprint and the extracted minutia of one or more other previously stored records. The accuracy of such an approach often depends upon the number of minutia that are utilized to characterize a given asperity pattern (that is, up to a point, the larger the number of utilized minutia, typically the more accurately and uniquely the given pattern can be characterized). Conversely, however, increasing asperity detection resolution will often significantly increase the necessary computational overhead required to process the additional information. As a result, increased accuracy becomes more difficult to reasonably achieve using these conventional approaches to asperity detection and characterization.

### BRIEF DESCRIPTION OF THE DRAWINGS

The above needs are at least partially met through provision of the method and apparatus for asperity detection described in the following detailed description, particularly when studied in conjunction with the drawings, wherein:

FIG. 1 comprises a block diagram as configured in accordance with an embodiment of the invention;

FIG. 2 comprises a side-elevational detailed schematic view of an asperity detector as configured in accordance with an embodiment of the invention;

FIG. 3 comprises a flow diagram as configured in accordance with an embodiment of the invention;

FIG. 4 comprises a side-elevational detailed schematic view of an asperity initially contacting an asperity detector as configured in accordance with an embodiment of the invention;

FIG. 5 comprises a side-elevational detailed schematic view of the asperity contacting an asperity detector at a later time as configured in accordance with an embodiment of the invention;

FIG. 6 comprises a perspective view of an illustrative asperity;

FIG. 7 comprises a top plan view of illustrative topographic characterizing information for the asperity of FIG. 6 as configured in accordance with an embodiment of the invention; and

FIG. 8 comprises a flow diagram as configured in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION

Generally speaking, pursuant to these various embodiments, asperity detection occurs over time. This permits characterizing a given asperity with respect to its topographic characteristics (and also, if desired, the topographic characteristics of the surface that supports the asperity). Such information can be use to characterize the asperity with respect to its apparent three-dimensional form factor. Such information can also be used to characterize the elasticity of the asperity (as the asperity is brought into contact with an asperity detection surface) and/or the resiliency of the asperity (as the asperity is removed from contact with an asperity detection surface).

Pursuant to one embodiment, points of contact between one or more asperities and an asperity detection surface are noted at a first time. At a later time (preferably a small fraction of a second later) the points of contact are again noted, with additional readings being taken and captured as desired and/or appropriate to a given application. The resultant information can then be used as suggested above to provide the temporally based asperity characterizing data.

This approach does not necessarily require increased asperity detection imaging resolution and therefore avoids at least most of the concerns that hamper adoption of other techniques that are intended to improve accuracy. Notwithstanding this benefit, these embodiments nevertheless contribute additional meaningful characterizing content that can significantly improve the accuracy and reliability of asperity-based identification and verification. In effect, then, improved accuracy based upon additional feature information is attained without a commensurate increase in resolution complexity.

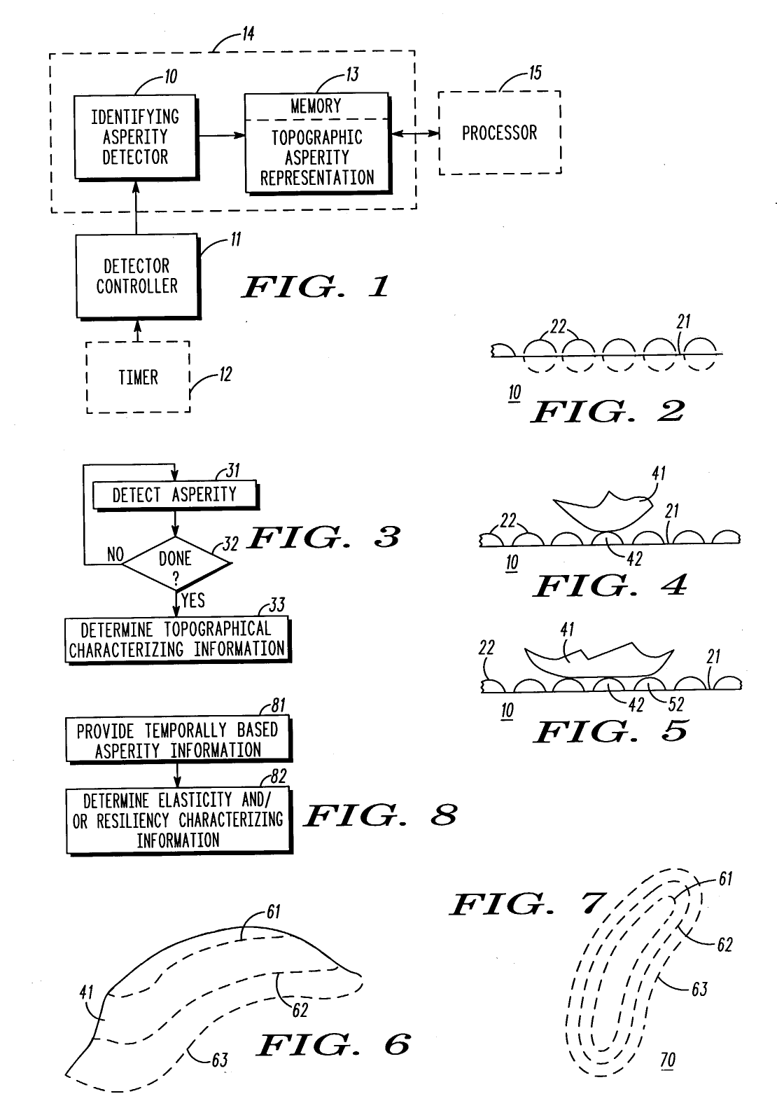

Referring now to the drawings, FIG. 1 presents a block diagram view of a platform to support the desired topographically and/or temporally-based asperity detection. A variety of identifying asperity detectors 10 can possibly serve for these purposes, but for a preferred embodiment, the identifying asperity detector 10 comprises a resistive discharge direct asperity reader. Such a reader is described in detail in U.S patent application 1487I filed on whenever, 2001 and entitled “Method and Apparatus for Asperity Sensing and Storage” (the contents of which are hereby incorporated by this reference).

Such an asperity detector is generally comprised of a plurality of memory cells that each include at least one charge storage device. This memory can comprise a solid-state memory such as, for example, a random access memory (though the memory can be comprised of a static random access memory if desired). In such a memory, the charged state of the charge storage device represents the logical 1 or 0 that is stored within that corresponding memory cell. An asperity contact surface overlies the memory cells. The asperity contact surface has a plurality of conductive paths formed through it such that at least some of the conductive paths are conductively coupled to at least some of the charge storage devices.

These conductive surfaces comprise electrode pads and are formed of any appropriate conductive material. Preferably, these conductive surfaces are gold plated (the asperity contact surface will provide mechanical and chemical protection as regards these conductive surfaces but some amount of moisture will still likely penetrate the asperity contact surface; such goldplating aids in preventing debilitating corrosion of the conductive surfaces). In addition, some of the conductive surfaces are coupled to a common rail. The conductive surfaces alternate with respect to being coupled to the charge storage devices and the common rail (in a preferred approach, in fact, the charge storage device coupled surfaces may outnumber the common rail coupled surfaces by approximately 100 to 1). Other arrangements and ratios are possible and may in fact provide improved performance in a given application context.

For an asperity capture device intended for use in sensing fingerprints, the identifying asperity detector 10 can be approximately 1.25 cm in width by 2.54 cm in length. The memory cells with their corresponding charge storage devices and conductive surfaces can preferably be disposed in an array to assure suitable sensor coverage of the entire portion of the fingerprint contact surface.

As shown in FIG. 2, the asperity contact surface 21 of the identifying asperity detector 10 may be comprised of an epoxy material and preferably an anisotropic material. The conductive paths as formed through the asperity contact surface can be comprised of conductive spheres 22. Such conductive spheres 22 can be approximately seven millionths of a meter in diameter and can be comprised of nickel. The nickel may preferably include an oxide coating about the sphere. As a result, although the spheres 22 will conduct electricity the spheres 22 also present considerable resistance to the flow of electricity.

One or more of the conductive spheres 22 are typically positioned proximal to one of the conductive surfaces. In fact, a plurality of conductive spheres are likely to be positioned proximal to any given conductive surface. For example, presuming the conductive surface and conductive sphere dimensions as set forth above, and presuming a sphere doping ratio of 15 to 25 percent, there will be approximately 8 to 12 conductive spheres in contact with each conductive surface. This level of redundancy assures that all conductive surfaces (and their corresponding memory cells) will be active and available for the asperity sensing and storage process.

The epoxy comprising the asperity contact surface 21 is both compressed and cured. Such compression and curing, however, may not insure that an exposed portion of the spheres 22 reliably results. Therefore, the exterior surface of the asperity contact surface 21 can be treated to ensure expose of a portion of the conductive spheres 22. For example, abrasion or plasma cleansing can be utilized to achieve this result.

When an object contacts the fingerprint contact surface, protruding aspects of the surface of the object will contact some of the conductive spheres and current will flow from the previously charged charge storage device and the conductive surface as corresponds thereto, through the conductive sphere that is in conductive contact with the conductive surface, through the object itself, and through another conductive sphere-conductive surface pair to reach the common rail. This, of course, will result in discharging that particular charge storage device. The discharged state of the charge storage device then serves as a characterizing indicia of the existence of the asperity at a particular location of the fingerprint contact surface.

Referring again to FIG. 1, the above described identifying asperity detector 10 serves to simultaneously sense and store tactile impressions information regarding asperities on the surface of an object that contacts the asperity contact surface. A detector controller 11 couples to the identifying asperity detector 10 and serves to control, for example, when and how the detector 10 operates (for example, by controlling charging of the charge storage devices of the detector 10). In these embodiments, the identifying asperity detector 10 captures a rapid series of asperity detection images. To facilitate this, the detector controller 11 can either include an integral timer or an outboard timer 12 can optionally be used instead. Such a timer (either internal or outboard) permits determination of predetermined time intervals, such as intervals as small as one one-hundredth or one-thousandth of a second in duration, to be accurately and reliably determined for use by the detector controller 11 as described below.

These embodiments preferably provide a memory to retain the results of the series of temporally spaced asperity detection events. This memory can fully or partially comprise an outboard memory 13 and/or can be fully or partially integrated with the identifying asperity detector 10 (as presented by the phantom line box denoted by reference numeral 14). In a preferred embodiment, when the identifying asperity detector 10 comprises a resistive discharge reader, the memory can at least largely comprise the charge storage devices of the reader itself.

If desired, a processor 15 can be included to permit subsequent processing of the asperity information. For example, topographic asperity representation information as retained in the memory 13 can be accessed by such a processor 15 to effect desired identification and/or authorization activities.

So configured, such a platform generally serves to provide at least one identifying asperity detector, a detector controller having a control output that operably couples to the identifying asperity detector to permit control thereof, and a memory operably coupled to the identifying asperity detector to permit, for example, the storage of topographic representations of the asperities of a given surface such as a fingertip. The topographic representations, as shown below in more detail, derive at least in part from temporally-spaced asperity detection events that together provide a composite topographic representation. As also will be shown below, such a platform can further capture such temporally-spaced asperity detection events to permit characterization as a function of elasticity and/or resiliency of the asperities and the underlying surface of the asperities.

Referring now to FIG. 3, the platform described (or such other enabling platform as may be desired) repeatedly detects asperities 31 on an external surface (such as a fingertip) over a short period of time. Such asperities can be, for example, the friction ridges that define fingerprints, palm prints, leather glove patterns, and the like. More particularly, in a preferred embodiment, such asperities are detected, at different times, by detecting a proximity relationship between such identifying asperities and a detection surface such as the ones described earlier. To illustrate, and referring now to FIG. 4, at a first moment in time when an external surface (such as a fingertip) approaches the asperity detector 10, an outermost portion of a given asperity 41 on the external surface makes first contact with a responsive portion of the asperity contact surface 21 (in particular, in this embodiment, a specific conductive sphere 42). Such points of contact serve to detect and provide an indication of a corresponding asperity feature. As the external surface continues to move towards the asperity detector 10, the asperity 41 compresses (as suggested in FIG. 5). Such compression frequently causes the asperity 41 to contact other adjacent or nearby conductive spheres (51 and 52 in this example) at a slightly later point in time from the moment captured in FIG. 4. By capturing this later information, the process captures additional asperity information.

With reference to FIGS. 6 and 7, it can be seen that different portions of a given asperity 41 are detected at different times as the material comprising the asperity becomes compressed against the asperity detector 10. In particular, the most outwardly extending portions of the asperity tend to first contact the detector 10 with other portions contacting the detector 10 at later times. For example, in the simple example illustrated, a most outward portion 61 of the asperity 41 will contact the detector 10 first, followed at a later time by a less outward portion 62 of the asperity 41, which is followed yet later by an even less outward portion 63 of the asperity 41. By noting which portions of the detector surface are contacted by the asperity as each given time, the resultant data can be used to determine a topographical representation 70 of the asperity as illustrated in FIG. 7. Such a representation provides information not only with respect to a general two dimensional configuration of the asperity (as is otherwise typically provided by most other asperity detection schemes) but also the three dimensional configuration thereof.

Such three dimensional topographic representations provide meaningful characterizing information regarding the identifying asperities of, for example, an individual. Such information can therefore be used to increase the reliability and accuracy of an asperity-based identification process.

Such information can also be used to characterize asperities (and/or the underlying external surface that supports the asperities) in other ways. For example, with reference to FIG. 8, following provision 81 of such temporally-based asperity information, elasticity and/or resiliency characterizing information for the asperity can also be determined 82. By detecting at various times a predetermined level of proximity (such as actual physical contact) between the asperity detection sensors and the asperity itself while the asperity is brought into proximity with the detector, elasticity characteristics of the asperity and/or the underlying surface of the asperity can be ascertained. In a similar manner, resiliency characteristics of the asperity and/or the underlying surface of the asperity can be ascertained by noting the same kinds of proximity relationships at various times as the asperity is removed from proximity with the detector. In particular, such characteristics reveal themselves as, over time, portions of the asperity make contact (or break contact) with the detector surface as a function of elasticity and/or resiliency of the asperity itself and/or the underlying support surface.

So configured, a variety of asperity detection/characterizing mechanisms can be realized. For example, a fingerprint reader can be readily provided by using the asperity detector 10 as a fingerprint reader surface. Then, as the fingerprint of an individual is moved with respect to such a fingerprint reader surface, the detector 10 can capture a series of representations of the friction ridges that have at least a predetermined degree of proximity, such as full physical contact, with the fingerprint reader surface at a time when the corresponding representation is captured. The resultant series of representations can then be used to form a topographic characterization of the fingerprint. Such a series of representations can be captured as the fingerprint moves towards the fingerprint reader surface, away from the fingerprint reader surface, or during both events.

The resolution of the resultant temporally-based information comprises a function, at least in part, of the duration of the time intervals between capturing such information. Resistive discharge direct asperity readers are potentially capable of reacting to capture intervals as brief as one thousandth of a second. For many purposes, however, useful and improved results can be obtained with considerably longer intervals between capture events.

The various embodiments set forth herein for asperity detection apparatus and methods all tend to provide increased quantities of characterizing information without requiring an increase with respect to two dimensional imaging resolution. As a result, accuracy and reliability can be increased without occasioning a commensurate increase with respect to, for example, the imaging resolution of a given approach. The three dimensional and/or time-based characterization of an asperity also serves to more completely characterize a given asperity and hence renders fraudulent activity less likely to succeed.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method, comprising:
detecting, over time, at least one identifying asperity on an external surface to provide asperity information;
using the asperity information to determine topographical characterizing information for the external surface.

2. The method of claim 1, wherein detecting further includes detecting, over time, a plurality of identifying asperities on an external surface that comprise friction ridges.

3. The method of claim of claim 2 wherein detecting further includes detecting, at different times, a proximity relationship between the plurality of identifying asperities and a detection surface.

4. The method of claim 3 wherein detecting, at different times, a proximity relationship includes detecting, at predetermined time intervals, the proximity relationship between the plurality of identifying asperities and the detection surface.

5. The method of claim 1 and further comprising:
providing a detection surface comprised of a plurality of asperity detection sensors;
and wherein detecting, over time, at least one identifying asperity on an external surface to provide asperity information further includes using the detection surface to detect, over time, the at least one identifying asperity on the external surface.

6. The method of claim 5 wherein detecting further includes:
detecting, at a first time, the asperity detection sensors that a given asperity has a predetermined proximity with to provide first asperity data;
detecting, at a second time, wherein the second time is later than the first time, the asperity detection sensors that the given asperity has the predetermined proximity with to provide second asperity data.

7. The method of claim 6 wherein using the asperity information to determine topographical characterizing information for the external surface includes using the first asperity data and the second asperity data to determine a topographic shape of the external surface.

8. The method of claim 7 wherein the external surface comprises at least a portion of a hand.

9. The method of claim 8 wherein the at least a portion of a hand comprises a fingertip.

10. The method of claim 6 wherein using the asperity information to determine topographical characterizing information for the external surface includes using the first asperity data and the second asperity data to determine a topographic shape of the given asperity.

11. The method of claim 5 wherein providing a detection surface comprised of a plurality of asperity detection sensors further includes providing memory integral to at least some of the plurality of asperity detection sensors.

12. A method, comprising:
detecting, over time, at least one identifying asperity on an external surface to provide temporally-based asperity information;
using the temporally-based asperity information to determine at least one of elasticity and resiliency characterizing information for the external surface.

13. The method of claim 12 and further comprising:
a plurality of asperity detection sensors;
and wherein detecting includes using the plurality of asperity detection sensors to detect, over time, the at least one identifying asperity on the external surface.

14. The method of claim 13 wherein using the plurality of asperity detection sensors to detect, over time, the at least one identifying asperity on the external surface further includes:
detecting at a first time the asperity detection sensors that have at least a predetermined proximity to the at least one identifying asperity to provide first time data;
detecting at a second, later time the asperity detection sensors that have at least the predetermined proximity to the at least one identifying asperity to provide second time data;
and wherein using the temporally-based asperity information to determine at least one of elasticity and resiliency characterizing information for the external surface includes using the first time data and the second time data to determine at least one of elasticity and resiliency characterizing information for the external surface.

15. The method of claim 14 wherein determining at least one of elasticity and resiliency characterizing information for the external surface comprises determining at least one of elasticity and resiliency characterizing information for a fingertip.

16. The method of claim 12 wherein detecting, over time, at least one identifying asperity on an external surface to provide temporally-based asperity information includes detecting, over time, as the external surface is moved towards an asperity detection surface, the at least one identifying asperity; and
wherein using the temporally-based asperity information to determine at least one of elasticity and resiliency characterizing information for the external surface comprises using the temporally-based asperity information to determine at least elasticity as corresponds to the external surface.

17. The method of claim 12 wherein detecting, over time, at least one identifying asperity on an external surface to provide temporally-based asperity information includes detecting, over time, as the external surface is moved away from an asperity detection surface, the at least one identifying asperity; and
wherein using the temporally-based asperity information to determine at least one of elasticity and resiliency characterizing information for the external surface comprises using the temporally-based asperity information to determine at least resiliency as corresponds to the external surface.

18. An apparatus comprising:
an identifying asperity detector;
a detector controller having a control output operably coupled to the identifying asperity detector;
a memory operably coupled to the identifying asperity detector and having a topographic representation stored therein of a surface that has an identifying asperity disposed therein, the topographic representation comprising a plurality of temporally-spaced asperity detection events for the identifying asperity.

19. The apparatus of claim 18 wherein the identifying asperity detector comprises a resistive discharge direct fingerprint reader.

20. The apparatus of claim 18 wherein the detector controller includes timing means for causing the identifying asperity detector to capture the asperity detection events at predetermined time intervals.

21. The apparatus of claim 20 wherein the predetermined time intervals are no more than one one-hundredth of a second in duration.

22. The apparatus of claim 18 wherein the identifying asperity detector and the memory are integrally formed with respect to one another.

23. A method of reading a fingerprint comprised of a plurality of characterizing friction ridges, comprising:
providing a fingerprint reader surface;
as the fingerprint is moved with respect to the fingerprint reader surface, capturing a series of representations of the friction ridges that have at least a predetermined degree of proximity with the fingerprint reader surface at a time when the corresponding representation is captured;
using the series of representations to form a topographic characterization of the fingerprint.

24. The method of claim 23 wherein as the fingerprint is moved with respect to the fingerprint reader surface, capturing a series of representations of the friction ridges that have at least a predetermined degree of proximity with the fingerprint reader surface at a time when the corresponding representation is captured includes as the fingerprint is moved towards the fingerprint reader surface, capturing a series of representations of the friction ridges that have at least a predetermined degree of proximity with the fingerprint reader surface at a time when the corresponding representation is captured.

25. The method of claim 23 wherein as the fingerprint is moved with respect to the fingerprint reader surface, capturing a series of representations of the friction ridges that have at least a predetermined degree of proximity with the fingerprint reader surface at a time when the corresponding representation is captured includes as the fingerprint is moved away from the fingerprint reader surface, capturing a series of representations of the friction ridges that have at least a predetermined degree of proximity with the fingerprint reader surface at a time when the corresponding representation is captured.

26. The method of claim 23 wherein the predetermined degree of proximity comprises physical contact.

27. The method of claim 23 wherein capturing a series of representations of the friction ridges further comprises capturing a series of representations of the friction ridges at predetermined time intervals.
